(19) United States
(12) Patent Application Publication
(10) Pub. No.: US 2022/0058710 A1
(43) Pub. Date: Feb. 24, 2022

(54) INFORMATION PROCESSING DEVICE, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Ai MIYATA, Okazaki-shi (JP); Mitsuhiro MIURA, Okazaki-shi (JP); Yusuke NAKADE, Nagoya-shi (JP); Shin SAKURADA, Toyota-shi (JP); Shuichi SAWADA, Nagoya-shi (JP); Satoshi KOMAMINE, Nagoya-shi (JP)

(73) Assignee: TOYOTA JIDOSHA KABUSHIKI KAISHA, Toyota-shi (JP)

(21) Appl. No.: 17/445,453

(22) Filed: Aug. 19, 2021

(30) Foreign Application Priority Data
Aug. 19, 2020 (JP) 2020-138681

(51) Int. Cl. G06Q 30/06

(52) U.S. Cl. CPC G06Q 30/0623; G06Q 30/0633; G06Q 30/0613

(57) ABSTRACT

An information processing device comprises a controller configured to: obtain sensing data acquired by sensing a user; perform an estimation of occurrence of a necessary article or unnecessary article for the user, based on the sensing data; and perform predetermined processing related to either selling and buying or transfer and acquisition of the necessary article or unnecessary article, based on a result of the estimation.

### BACKGROUND

### Technical Field

The present disclosure relates to a technique for promoting the reuse of articles.

### Description of the Related Art

According to changes in life stage, goods such as living wares and furniture may become newly necessary or become unnecessary. In addition, recently, reuse of disused goods has been actively performed through a transaction platform.

As a technique in connection with this, for example, Japanese Patent Laid-Open No. 2003-050859 discloses a platform for matching a user desiring to transfer secondhand goods and a user desiring to acquire the secondhand goods.

### SUMMARY

In the existing technique, the users have to access the platform to exchange information such as descriptions of a transfer article and contact details; and there is room for improvement in saving the user's time and effort.

It is an object of the present disclosure to provide a technique for promoting the reuse of articles.

The present disclosure in its one aspect provides an information processing device comprising: a controller configured to: obtain sensing data acquired by sensing a user; perform an estimation of occurrence of a necessary article or unnecessary article for the user, based on the sensing data; and perform predetermined processing related to either selling and buying or transfer and acquisition of the necessary article or unnecessary article, based on a result of the estimation.

The present disclosure in its another aspect provides an information processing system, comprising: a first information processing device and a second information processing device; wherein the first information processing device includes a first controller configured to: obtain sensing data acquired by sensing a user; perform an estimation of occurrence of a necessary article or an unnecessary article for the user, based on the sensing data; and transmit necessity data to the second information processing device, the necessity data indicating necessity of the article for each user; and the second information processing device includes a second controller configured to execute predetermined processing based on the necessity data, the predetermined processing being related to either selling and buying or transfer and acquisition of the necessary article or the unnecessary article.

The present disclosure in its another aspect provides an information processing method, comprising the steps of: obtaining sensing data acquired by sensing a user; performing an estimation of occurrence of a necessary article or an unnecessary article for the user, based on the sensing data; and performing predetermined processing related to either selling and buying or transfer and acquisition of the necessary article or the unnecessary article, based on a result of the estimation.

In addition, another aspect is a program for causing a computer to execute the above information processing method or a non-transitory computer readable storage medium storing the above program.

According to the present disclosure, a technique for promoting the reuse of articles can be provided.

### BRIEF DESCRIPTION OF THE DRAWINGS

FIG. 1 is a diagram for describing an overview of a system according to a first embodiment;

FIG. 2 is a diagram illustrating, in detail, components of a home server according to the first embodiment;

FIG. 3 is a diagram illustrating a relationship between modules in the first embodiment;

FIGS. 4A to 4C are diagrams for describing data that is stored in a storage unit;

FIG. 5 is a diagram illustrating, in detail, components of a center server according to the first embodiment;

FIG. 6 is a flowchart of processing that is performed by the home server in the first embodiment;

FIG. 7 is a flowchart of processing that is performed by the center server in the first embodiment;

FIG. 8 is a diagram illustrating, in detail, components of a center server according to a second embodiment;

FIG. 9 is a diagram for describing an overview of a system according to the second embodiment;

FIG. 10 is a flowchart of processing that is performed by the center server in the second embodiment; and

FIG. 11 is a diagram for describing an overview of a system according to a third embodiment.

### DESCRIPTION OF THE EMBODIMENTS

Herein, an information processing device will be disclosed that determines the necessity of articles such as living wares and furniture based on a result of observing a user. A system determines the occurrence of an article that is newly necessary or the occurrence of an article that is unnecessary for a user; thereby, allowing, for example, transactions of secondhand articles between users to be encouraged.

The information processing device according to an embodiment includes a control unit that obtains sensing data acquired by sensing a user, performs an estimation of the occurrence of an article necessary or an article unnecessary for the user based on the sensing data, and performs predetermined processing related to selling/buying or transfer/acquisition of the necessary article or the unnecessary article based on a result of the estimation.

The sensing data indicates a result of sensing the daily life, activity, and the like of a user. The sensing data may be, for example, data acquired by directly observing the user (such as image data and voice data). In addition, the sensing data may be data acquired by indirectly observing the user (such as positional information of a terminal used by the user and network traffic by the terminal).

The article in the present disclosure typically includes furniture, daily goods, living wares, travel goods, and the like; however, is not limited to them.

The control unit can estimate that a specified user needs a new article (or will need it in the future) or no longer needs an owned article (or will no longer need it in the future).

As the predetermined processing, for example, processing of mediating in selling/buying or rental of secondhand articles is performed, thereby allowing an enhancement in the convenience of the user.

In addition, the control unit may determine a user class corresponding to the user based on the sensing data.

The user class is one obtained by classifying the life style or status of a user; for example, “being within a predetermined age range,” “having a predetermined family structure,” or “working in a predetermined occupation.” The user class may those related to a person who lives in the same house as the user. For example, the user class may be “the age of a child being within a predetermined range,” or “a child having started school.” In addition, the user class may indicate an event that will occur in the future, such as “being scheduled to give birth,” “being scheduled to go on to higher education,” or “being scheduled to move.”

The control unit determines a user class corresponding to a target user based on the sensing data. For example, when the number of persons who live in a home increases or decreases, it can be determined that a user class based on a family structure has changed.

In addition, the information processing device may include a storage unit that stores item data in which an article that is likely to be used by a user in a daily life is associated with each user class; and the control unit may perform the estimation based on the user class and the item data.

An example of the item data may be data that defines, for each user class, an article that is likely to be used in a daily life.

According to such a configuration, a determination of “since the user belongs to a class of ‘being scheduled to give birth’, there is a high possibility that a baby bed will become necessary” can be performed.

In addition, the user class may include an attribute related to the user and an attribute related to a family of the user.

In addition, the attribute may include at least any of a health condition, family structure, and age.

This is because, according to the health condition, family structure, age, or the like, the size, quantity, and the like of an apparatus, tool, and furniture which are necessary in a daily life can vary.

In addition, the sensing data may include positional information of the user which is received from a user terminal, and the control unit may determine the user class based on a history of the positional information of the user.

By using the history of positional information of a user, a user class can be determined. For example, in a case where a user regularly goes to an obstetrics and gynecology hospital, it can be estimated that the user is expecting a baby. In addition, for example, in a case where a user goes to a nursery school or kindergarten in the morning and evening time periods, it can be estimated that the user has a child.

In addition, the predetermined processing may be processing of generating necessity data that indicates the necessity of the article for each of the users and registering the necessity data in a database.

The necessity data is, for example, data indicating that an article is necessary (or has become necessary) or an article is unnecessary (or has become unnecessary) for a user. By registering the data in the database, the reuse of disused articles can be promoted.

In addition, a second aspect of the present disclosure is an information processing system including the above-mentioned information processing device (a first information processing device) and a second information processing device.

The first information processing device includes a first control unit that transmits the above-mentioned necessity data to the second information processing device; and the second information processing device includes a second control unit that executes predetermined processing related to selling/buying or transfer/acquisition of the necessary article or unnecessary article.

The second control unit may perform, as the predetermined processing, processing of performing matching between a first user providing an article and a second user acquiring the article based on the necessity data.

According to such a configuration, transaction of an article between a plurality of users can be mediated.

The second control unit may generate an instruction to deliver the article from the first user to the second user.

The instruction may be, for example, transmitted to a device that is managed by a delivery company or transportation company. This allows arrangements for delivering an article to be automatically made.

The second control unit may perform, as the predetermined processing, processing of generating contract data related to the rental or selling/buying of the article based on the necessity data.

The contract data may be, for example, for a business operator doing rental business or sales business of articles.

The second control unit may generate an instruction to deliver the article to the user or to collect the article from the user.

According to such a configuration, arrangements for lending or returning an article can be automatically made.

The second control unit may transmit the instruction to a server device that manages a moving body for transporting the article.

The moving body for transporting an article may be a vehicle driven by a person or an autonomous vehicle. Utilization of an autonomous vehicle as the moving body allows delivery and collection of an article to be automated.

Hereinafter, embodiments of the present disclosure will be described with reference to drawings. Configurations of the embodiments below are illustrative and the present disclosure is not limited to the configurations of the embodiments.

### First Embodiment

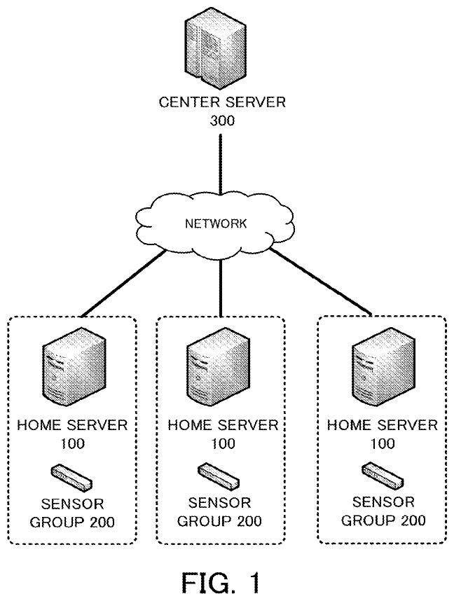

An overview of an information processing system according to a first embodiment will be described with reference to FIG. 1. The system according to this embodiment includes: a home server 100 installed in a home of a user; a sensor group 200 associated with the home server 100; and a center server 300.

The home server 100 is a computer installed in the home of the user. The home server 100 senses the user by using the sensor group 200; and based on its result, performs an estimation of the occurrence of an article that is newly necessary or an article that is unnecessary in a daily life of the user. In addition, it transmits related data to the center server 300 based on a result of the estimation.

The home server 100 may be a plurality of home servers 100. In this embodiment, a plurality of home servers each of which is associated with each of a plurality of users (or a plurality of families) is collectively referred to as the home server 100. In addition, the article is referred to as an item.

The center server 300 is a computer that manages the plurality of home servers 100. The center server 300 performs matching between a user who needs an item and a user who does not need the item any longer, based on data received from the plurality of home servers 100.

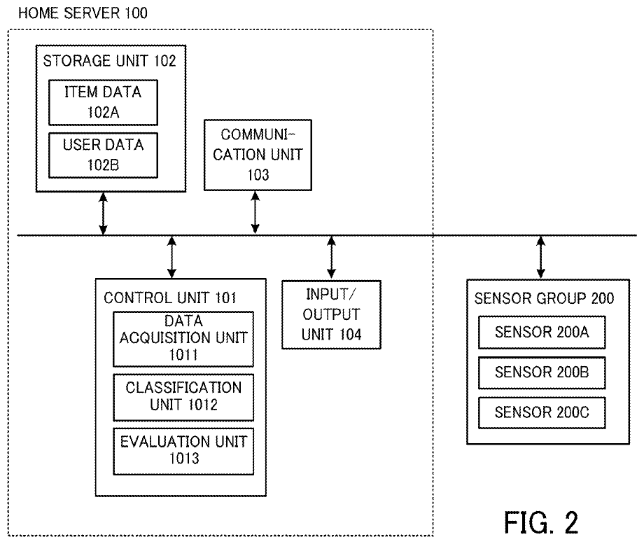

FIG. 2 is a diagram illustrating, in more detail, components of each of the home servers 100 and the sensor group 200 according to this embodiment.

Here, sensors included in the sensor group 200 will be described first.

The sensor group 200 includes a plurality of sensors 200A, 200B, . . . installed indoors. The plurality of sensors may be any kinds of sensors as long as they can obtain data for detecting the presence, activity, attribute, lifestyle, living environment, or the like of a user. Examples of them may include: a camera (image sensor) obtaining a visible light image or an infrared image; and a sound collector. In addition, combination of them is acceptable. Furthermore, they may include a sensor that, when there are a plurality of people indoors, can identify each of them.

Each of the plurality of sensors is configured so as to be able to output sensor data. When one of the sensors is an image sensor, the sensor data may be image data.

The sensors included in the sensor group 200 are preferably installed separately in a plurality of locations so as to sense a user. For example, in a case where the home of a user is targeted, each sensor may be installed in each of a plurality of rooms.

The home server 100 determines the necessity of a predetermined item for a user based on sensor data acquired by sensing the user and preliminarily stored data; and transmits its result to the center server 300. A detailed method will be described later.

The home server 100 may consist of a general-purpose computer. More specifically, the home server 100 can be configured as a computer that includes a processor such as a CPU, GPU, or the like, a main memory such as a RAM, ROM, or the like, and an auxiliary memory such as an EPROM, hard disk drive, removable media, or the like. Note that examples of the removable media may include a USB memory and disk recording media such as CD and DVD. In the auxiliary memory, an operating system (OS), various programs, various tables, and the like are stored, and a program stored therein is loaded into a work area of the main memory and is executed. Through the execution of the program, each component and the like are controlled and thereby, each function corresponding to a predetermined purpose as described later can be implemented. However, part or all of the functions may be implemented by a hardware circuit such as an ASIC or FPGA.

A control unit 101 is an arithmetic unit that manages control performed by the home server 100. The control unit 101 can be implemented by an arithmetic processing unit such as a central processing unit (CPU).

The control unit 101 is configured with three function modules of a data acquisition unit 1011, a classification unit 1012, and an evaluation unit 1013. Each of the function modules may be implemented by executing a program, which is stored in a storage unit 102 described later, by the CPU.

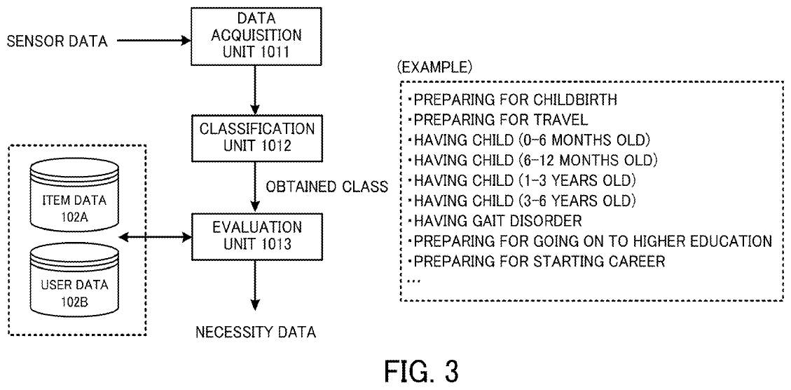

The three function modules will be described with reference to FIG. 3 that illustrates data transmitted and received between the modules.

The data acquisition unit 1011 obtains sensor data from sensors included in the sensor group 200. The sensor data to be obtained may be either image data (visible light image or infrared image) or voice data. In addition, it may be other data or a combination of them.

In addition, the data acquisition unit 1011 may perform predetermined processing for the obtained sensor data. For example, it may convert the sensor data into a feature value; or may analyze the sensor data and obtain its result.

For example, when the sensor data is image data, it may perform image recognition to obtain the identifiers, number, height, states, and postures of persons included in the image. In addition, when the sensor data is voice data, it may perform voice recognition to obtain text indicating the contents of conversation.

The classification unit 1012 classifies a user into a predetermined class by using data obtained by the data acquisition unit 1011 and a preliminarily built machine learning model (hereinafter, a classification model). In this embodiment, a plurality of classes are preliminarily defined and a machine learning model (classification model) for performing classification into each of the classes is built beforehand; and then, classification is performed by using the model.

The classification model, which is a preliminarily built machine learning model, allows input data to be classified into any one of the preliminarily defined plurality of classes. The classification unit 1012 inputs data obtained by the data acquisition unit 1011 into a classification model, and obtains a classification result as an output. In this example, a class of “preparing for childbirth” is obtained, for example.

A defined user class may be the one related to the activity, state, attribute, or the like of a user and its family. In addition, the user class may be the one related to a future event of the user and its family (for example, giving birth, going on to higher education, starting a career, moving out, and marriage). Furthermore, the user class may be the one related to a health condition (such as good condition, difficulty in walking, needed-support condition, or condition of need for long-term care), a family structure (such as the presence/absence of a partner, children, and kin living together), an age bracket, or the like.

It should be noted one user may belong to two or more user classes at the same time.

The evaluation unit 1013 determines an item which a user belonging to a certain class needs (or will need in the future) or an item which the user does not need any longer (or will not need in the future), based on item data 102A and user data 102B stored in the storage unit 102 which are described later.

Here, the item data 102A and the user data 102B are described.

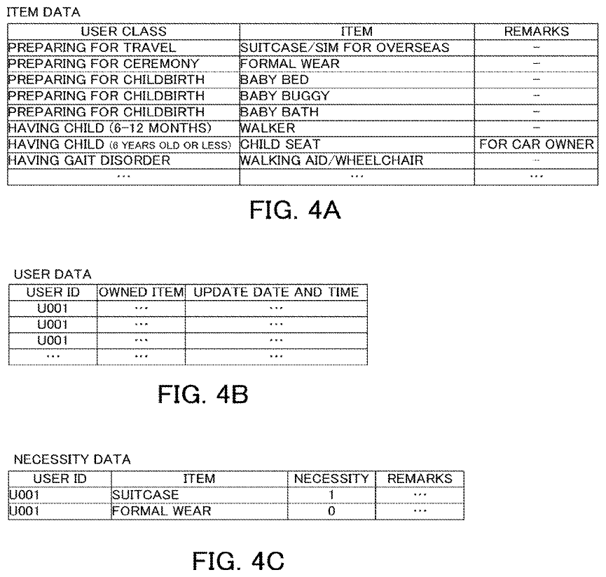

FIG. 4A is an example of the item data 102A. In the item data 102A, an item which a user will need in a daily life is associated with each user class. In the example of FIG. 4A, it is defined, for example, that when the user class is “preparing for childbirth,” a “baby bed,” “baby buggy,” and “baby bath” become necessary.

FIG. 4B is an example of the user data 102B. The user data 102B is a list of items which a user owns. The home server 100 updates the user data 102B when the user purchases, sells, disposes of, rents an item. The user data 102B may be managed by the user itself, or may be automatically updated by the system based on a sensing result.

The evaluation unit 1013 refers to the item data 102A and the user data 102B and if the following conditions are met, determines that the user “needs a currently not-owned item.”

(1) One or more items are associated with at least any one of the user classes corresponding to the user.
(2) The user does not own the item currently.

In addition, if the following conditions are met, the evaluation unit 1013 determines that the user “does not need a currently owned item any longer.”

(1) There is an item which the user currently owns.
(2) The item is not associated with any of the user classes corresponding to the user.

The evaluation unit 1013 generates necessity data based on a determination result. In the necessity data, an identifier of a user, an identifier of an item, and the necessity of the item are associated with each other.

FIG. 4C is an example of the necessity data. A value “1” recorded in the “NECESSITY” column represents “needs a currently not-owned item.” A value “0” represents “does not need a currently owned item.”

The necessity data may hold information on details of the item (for example, size and color).

This example provides illustration for a single user; however, when there are a plurality of users, the evaluation unit 1013 may generate necessity data for each of the plurality of users.

The evaluation unit 1013 transmits the generated necessity data to the center server 300.

The storage unit 102 includes a main memory and an auxiliary memory. The main memory is a memory where a program executed by the control unit 101 and data used by the control program are deployed. The auxiliary memory is a device where a program executed by the control unit 101 and data used by the program are stored. The auxiliary memory may store the program executed by the control unit 101 which has been packaged as an application. In addition, it may store an operating system for executing such applications. The program stored in the auxiliary memory is loaded to the main memory and executed by the control unit 101, thereby causing processing described later to be performed.

The main memory may include a random access memory (RAM) and a read only memory (ROM). The auxiliary memory may include an erasable programmable ROM (EPROM) and a hard disk drive (HDD). In addition, the auxiliary memory may include a removable media, that is, a removable recording medium. Examples of removable media include a universal serial bus (USB) memory and disk recording media such as a compact disc (CD) and a digital versatile disc (DVD).

In addition, the storage unit 102 stores the item data 102A and the user data 102B which are described earlier.

Returning to FIG. 2, description will be continued.

The communication unit 103 is a wireless communication interface for connecting the home server 100 to a network. The communication unit 103 is, for example, configured to be communicable with the center server 300 via a wireless LAN and a mobile communication service such as, 3G, LTE, or 5G.

The input/output unit 104 is a unit that accepts an input operation performed by a user and presents information to the user. In this embodiment, it consists of a touch panel display. More specifically, it is composed of a liquid crystal display and control unit thereof, and a touch panel and control unit thereof.

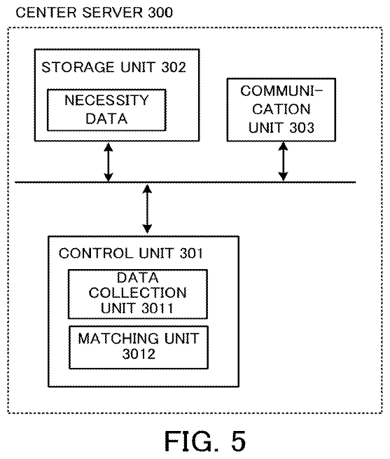

Next, the center server 300 will be described. FIG. 5 is a diagram illustrating, in more detail, components of the center server 300 according to this embodiment.

The center server 300 is a server device that performs matching between a user who provides an item and a user who wants the item, based on necessity data transmitted from the plurality of home servers 100.

The center server 300 also can consist of a general-purpose computer, as with the home servers 100. More specifically, the center server 300 can be configured as a computer that includes a processor such as a CPU or a GPU, a main memory such as RAM or ROM, and an auxiliary memory such as an EPROM, a hard disk drive, or removable media.

The control unit 301 is an arithmetic unit that manages control performed by the center server 300. The control unit 301 can be implemented by an arithmetic processing unit such as a central processing unit (CPU).

The control unit 301 is configured with two function modules of a data collection unit 3011 and a matching unit 3012. Each of the function modules may be implemented by executing a program, which is stored in a storage unit 302 described later, by the CPU.

The data collection unit 3011 collects necessity data from the plurality of home servers 100 and stores it in the storage unit 302 described later.

The matching unit 3012 performs matching between users based on the necessity data stored in the storage unit 302; and provides its result to corresponding home servers 100. More specifically, it performs matching between a user who is determined as not needing an item and a user who is determined as needing the item; and transmits its result to home servers 100 respectively corresponding to the users.

The storage unit 302 includes a main memory and an auxiliary memory. The main memory is a memory where a program executed by the control unit 301 and data used by the control program are deployed. The auxiliary memory is a device where a program executed by the control unit 301 and data used by the control program are stored.

The storage unit 302 stores necessity data collected from the home servers 100.

A communication unit 303 is a communication interface similar to the communication unit 103. The communication unit 303 is configured to be communicable with the home servers 100 via a wide-area network such as the Internet, for example.

Each of the configurations illustrated in FIG. 2 and FIG. 5 is one example and the whole or part of the illustrated functions may be executed by using an exclusively designed circuit. Furthermore, the storage or execution of a program may be performed by a combination of a main memory and an auxiliary memory, other than the one illustrated.

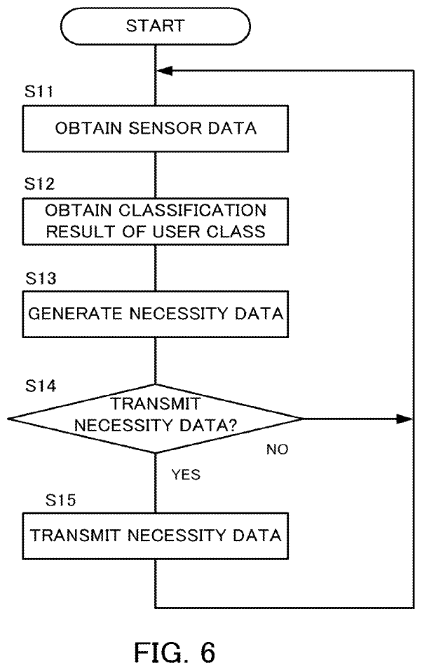

Next, processing executed by each of the home servers 100 will be described. FIG. 6 is a flowchart of processing executed by the home server 100.

First, at step S11, the data acquisition unit 1011 obtains sensor data transmitted from sensors included in the sensor group 200. The data acquisition unit 1011 may temporarily accumulate the sensor data until having collected enough data to perform classification. In addition, the data acquisition unit 1011 may perform analysis, processing, and the like for the obtained sensor data.

Next, at step S12, the classification unit 1012 inputs the data acquired by the data acquisition unit 1011 into a classification model and obtains a classification result (user class).

At step S13, the evaluation unit 1013 generates necessity data by the processing described earlier, based on the user class obtained by the classification unit 1012, the item data 102A, and the user data 102B.

At step S14, the evaluation unit 1013 determines whether requirements for transmitting the necessity data to the center server 300 are met.

For example, the necessity of an article may not be determined correctly by only one determination for a user class. For example, when the number of people who are present in a home increases, it is difficult to immediately determine whether the number of inhabitants has increased or a visitor has come. Therefore, processing from steps S11 to S13 is repeatedly executed and only when requirements are met (for example, when an identical user class is obtained a predetermined number of times or more), the necessity data may be transmitted. This allows the necessity data to be transmitted only in a case of a highly likely situation.

If an affirmative determination is made at step S14, processing transitions to step S15, where the evaluation unit 1013 transmits the necessity data to the center server 300. If a negative determination is made, the processing returns to step S11.

The transmitted necessity data is received by the center server 300 (data collection unit 3011) and is stored in the storage unit 302.

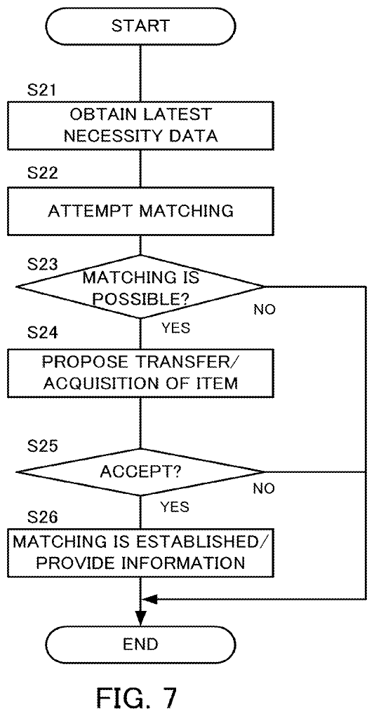

Next, processing executed by the center server 300 will be described. FIG. 7 is a flowchart of processing executed by the center server 300 (matching unit 3012). The illustrated processing is, for example, executed in a predetermined cycle.

First, at step S21, the latest necessity data stored in the storage unit 302 is obtained.

Next, at step S22, matching between users is attempted by using an item included in the necessity data as a key. More specifically, matching between a user who does not need an item (or is expected not to need it) any longer and a user who needs the item (or is expected to need it) is performed.

If it is determined that the matching is possible as a result of this (step S23: YES), the processing transitions to step S24, where a proposal to transfer and acquire the item is offered to both of the users. For example, it is confirmed whether a user to provide an item can transfer the item and whether a user to acquire the item desires to acquire the item. In this case, an inquiry about a transfer price of the item may be made.

If it is determined that the matching is not established at step S23, the processing ends.

If both of the users accept the proposal (step S25: YES), the processing transitions to step S26, where each other's information is provided to each of the users. This allows both of the users to perform delivery of the item. If either of the users does not accept the proposal, the processing ends.

As described above, the information processing system according to the first embodiment determines a class to which a user belongs, based on a result of sensing the user; and determines an article which the user needs or an article which the user does not need, based on the class. By performing this for a plurality of users, matching between users for transfer of an article can be automatically performed.

(Modification of the First Embodiment)

The sensors included in the sensor group 200 are not limited to those directly sensing a user. For example, a network switch installed in a home of a user may obtain communication traffic of the user. More specifically, data which is transmitted/received by the user using a computer may also be considered as sensor data.

For example, if a user has searched for information on a childbirth subsidy, it can be estimated that the user belongs to the class of “preparing for childbirth.”

In addition, the sensors included in the sensor group 200 are not necessarily required to be fixed. For example, a terminal (user terminal) carried by a user may be treated as one of the sensors. In this case, the user terminal may be configured to transmit sensor data to a home server 100. For example, the user terminal may periodically transmit positional information to the home server 100, and the home server 100 may treat the positional information as sensor data corresponding to the user.

In this case, the home server 100 can obtain data related to travel of the user (for example, location which the user has visited, date and time, and number of times), and store it in the storage unit 102. In addition, the classification unit 1012 can determine a user class based on such data (for example, a history of positional information). Therefore, the home server 100 may store data (for example, a table or a machine learning model) for determining a user class based on the history of positional information.

In the first embodiment, matching between users is performed only based on necessity data; however, matching between users may be performed in consideration of other elements (for example, addresses of the users).

In addition, in the first embodiment, processing of introducing users to each other is performed; however, only a notification that there is a user who wants an item or there is a user who can provide an item may be provided without directly introducing the user and another service may be encouraged.

### Second Embodiment

In the first embodiment, transfer of an article (secondhand item) is mediated by performing matching between users. On the other hand, in a second embodiment, a procedure for purchasing or renting an article is automatically performed.

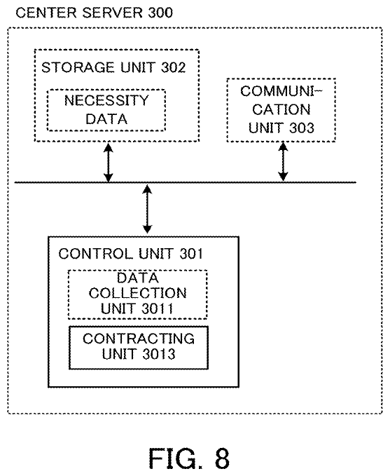

FIG. 8 is a diagram illustrating, in more detail, components of the center server 300 according to the second embodiment.

The second embodiment is different from the first embodiment in that the control unit 301 has a contracting unit 3013 instead of the matching unit 3012.

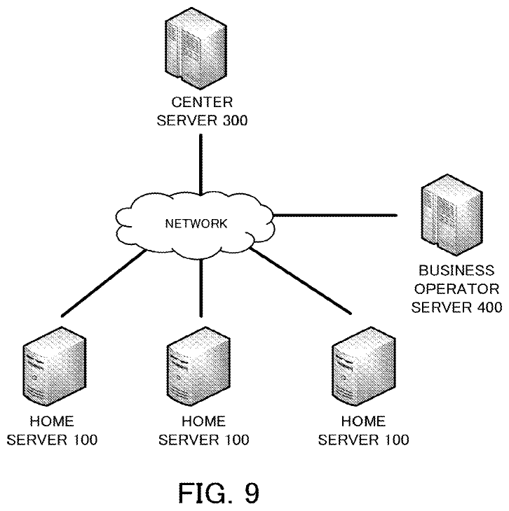

As illustrated in FIG. 9, in the second embodiment, the center server 300 is configured to be further communicable with a business operator server 400. The business operator server 400 is a server device that is managed by a business operator renting or selling articles. The business operator server 400 may exist for each of a plurality of business operators.

The contracting unit 3013 generates contract data for the business operator server 400.

Examples of the contract data may include:
Data for applying for contract for renting an article
Data for requesting to end a contract for renting an article
Data for applying for purchasing an article
Data for applying for selling an article

The contract data includes, for example, data for identifying a target article, a contract period (in the case of renting an article), and user information.

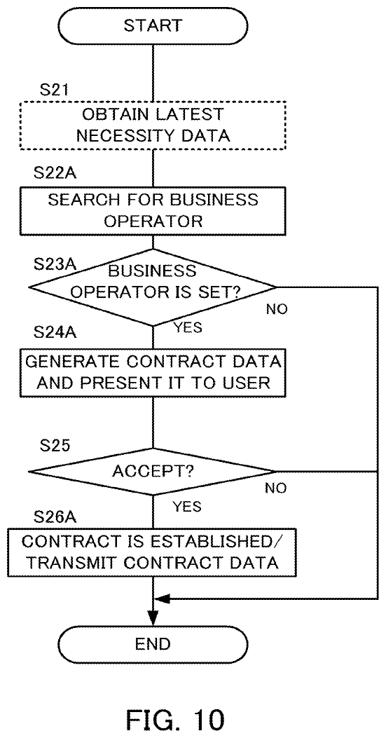

FIG. 10 is a flowchart of processing that is performed by the center server 300 (contracting unit 3013) in the second embodiment.

In the second embodiment, after necessity data is obtained at step S21, a business operator dealing in articles is searched for at step S22A. For example, a business operator capable of renting, selling, buying, and the like of a target article is searched for by communicating with an external device.

Next, at step S23A, it is determined whether a business operator has been set. If a business operator is not found, the processing ends.

At step S24A, contract data is generated and the contract data is presented to a user. Here, if the user accepts the contract (step S25: YES), the processing transitions to step S26A, where the contract data is transmitted to the business operator server 400. If not accepting the contract (step S25A: NO), the processing ends.

According to the second embodiment, transaction with a business operator dealing in articles can be facilitated.

It should be noted that although contract data is generated in this embodiment, only introduction (recommendation) of a business operator may be performed without generating contract data.

### Third Embodiment

In the first and second embodiments, a user or a business operator is required to make arrangements for transporting an article. On the other hand, in the third embodiment, when it is necessary to transport an article, an autonomous vehicle for transporting the article is arranged by the center server 300.

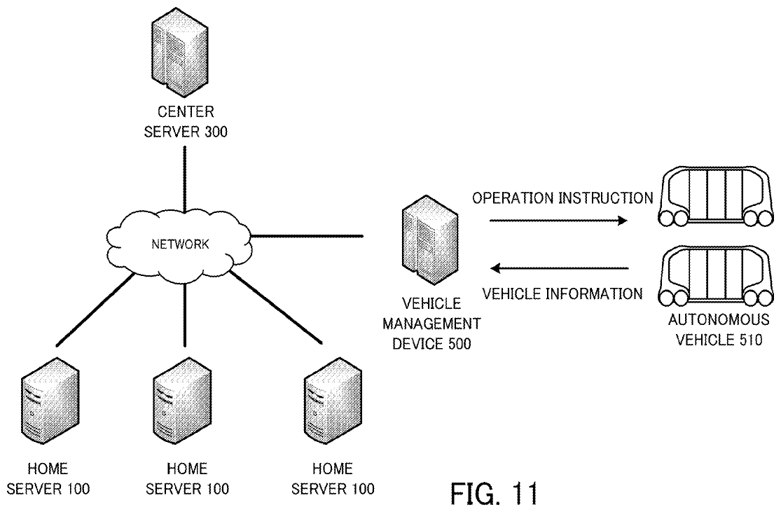

As illustrated in FIG. 11, in the third embodiment, the center server 300 is configured to be communicable with a vehicle management device 500. The vehicle management device 500 is a device that manages a plurality of autonomous vehicles 510.

The vehicle management device 500 collects, from the plurality of autonomous vehicles 510 under management, information on each of the vehicles (vehicle information, such as positional information and vehicle status). In addition, it transmits, to the plurality of autonomous vehicles 510 under management, data for instructing to operate (operation instruction). This allows each of the autonomous vehicle 510 to operate along a specified route.

The operation instruction may include data for specifying a travel route, a passing point, and a destination. In addition, the operation instruction may include data for specifying processing to be performed on the route. Examples of the processing to be performed on the route include calling a user, loading an article, and delivering an article.

When the third embodiment is combined with the first embodiment, the center server 300 generates an operation instruction for instructing to “take an article from a user who is a transferor and deliver the article to a user who is a transferee.” This processing is executed after step S26 in FIG. 7 is complete.

In addition, when the third embodiment is combined with the second embodiment, the center server 300 generates an operation instruction for instructing, for example, to “take an article from a business operator who provides the article (a rental business operator or sales business operator) and deliver the article to a user.” Otherwise, it generates an operation instruction for instructing to “collect an article to be returned from a user and deliver the article to a rental business operator.” This processing is executed after step S26A in FIG. 10 is complete.

It should be noted that the center server 300 may determine the date and time when the autonomous vehicle 510 is operated after checking the schedule of a user or a business operator that is a party and the schedule of the vehicle.

According to the third embodiment, arrangements for transporting an article can be automatically made.

(Modification)

The above embodiments are merely one example, and the present disclosure may be appropriately modified and implemented without departing from the spirit thereof.

For example, the processing and units described in the present disclosure can be implemented by being freely combined as long as a technical contradiction does not occur.

In addition, in the description of the embodiments, procedures related to the selling/buying or transfer/acquisition of an article are performed as predetermined processing; however, only recommendation may be performed.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disc, Blu-ray disc, etc.); and any type of medium suitable for storing electronic instructions, such as read-only memory (ROM), random access memory (RAM), EPROM, EEPROM, magnetic cards, flash memory, and optical cards.

What is claimed is:

1. An information processing device comprising:
a controller configured to:
obtain sensing data acquired by sensing a user;
perform an estimation of occurrence of a necessary article or unnecessary article for the user, based on the sensing data; and
perform predetermined processing related to either selling and buying or transfer and acquisition of the necessary article or unnecessary article, based on a result of the estimation.

2. The information processing device according to claim 1, wherein
the controller determines a user class corresponding to the user, based on the sensing data.

3. The information processing device according to claim 2, further comprising:
a storage configured to store item data, the item data having an article associated with each user class, the article being likely to be used by the user in a daily life; wherein
the controller performs the estimation based on the user class and the item data.

4. The information processing device according to claim 2, wherein
the user class includes an attribute related to the user and an attribute related to a family of the user.

5. The information processing device according to claim 4, wherein
the attribute includes at least any of a health condition, family structure, and age.

6. The information processing device according to claim 2, wherein
the sensing data includes positional information of the user, the positional information being received from a user terminal and
the controller determines the user class based on a history of the positional information of the user.

7. The information processing device according to claim 6, wherein
the predetermined processing includes:
generating necessity data indicating necessity of the article for each user; and
registering the necessity data in a database.

8. An information processing system, comprising:
a first information processing device and a second information processing device; wherein
the first information processing device includes a first controller configured to:
obtain sensing data acquired by sensing a user;
perform an estimation of occurrence of a necessary article or an unnecessary article for the user, based on the sensing data; and
transmit necessity data to the second information processing device, the necessity data indicating necessity of the article for each user; and
the second information processing device includes a second controller configured to execute predetermined processing based on the necessity data, the predetermined processing being related to either selling and buying or transfer and acquisition of the necessary article or the unnecessary article.

9. The information processing system according to claim 8, wherein
the first controller determines a user class corresponding to the user based on the sensing data.

10. The information processing system according to claim 9, wherein
the first information processing device further includes a storage configured to store item data, the item data having an article associated with each user class, the article being likely to be used by the user in a daily life; and
the first controller performs the estimation based on the user class and the item data.

11. The information processing system according to claim 9, wherein
the user class includes an attribute related to the user and an attribute related to a family of the user.

12. The information processing system according to claim 11, wherein
the attribute includes at least any of a health condition, family structure, and age.

13. The information processing system according to claim 9, wherein
the sensing data includes positional information of the user, the positional information being received from a user terminal and
the first controller determines the user class based on a history of the positional information of the user.

14. The information processing system according to claim 8, wherein
the first information processing device generates the necessity data for each of a plurality of users.

15. The information processing system according to claim 8, wherein
the second controller processing performs, as the predetermined processing, processing of performing matching between a first user and a second user based on the necessity data, the first user providing an article, the second user acquiring the article.

16. The information processing system according to claim 15, wherein
the second controller generates an instruction to deliver the article from the first user to the second user.

17. The information processing system according to claim 8, wherein
the second controller performs, as the predetermined processing, processing of generating contract data related to rental or selling and buying of the article, based on the necessity data.

18. The information processing system according to claim 17, wherein
the second controller generates an instruction to deliver the article to the user or to collect the article from the user.

19. The information processing system according to claim 16, wherein
the second controller transmits the instruction to a server device managing a moving body, the moving body transporting the article.

20. An information processing method, comprising the steps of:
obtaining sensing data acquired by sensing a user;
performing an estimation of occurrence of a necessary article or an unnecessary article for the user, based on the sensing data; and
performing predetermined processing related to either selling and buying or transfer and acquisition of the necessary article or the unnecessary article, based on a result of the estimation.
